(19) United States
(12) Patent Application Publication
(10) Pub. No.: US 2025/0298439 A1
(43) Pub. Date: Sep. 25, 2025

(54) SLOT DEVICE

(71) Applicant: Fulian Precision Electronics (Tianjin) Co., LTD, Tianjin (CN)

(72) Inventors: CHIA-YI WU, New Taipei (TW); Yun-Cheng Hsieh, New Taipei (TW)

(21) Appl. No.: 18/969,507

(22) Filed: Dec. 5, 2024

Related U.S. Application Data
(60) Provisional application No. 63/568,517, filed on Mar. 22, 2024.

(51) Int. Cl. G06F 1/16; G01K 1/14; G01K 7/01

(52) U.S. Cl. CPC G06F 1/1632; G01K 1/14; G01K 7/01

(57) ABSTRACT

A slot device is disclosed in the present application. The slot device includes a slot body, a first moving portion, a second moving portion, and a sensor, the first moving portion reciprocates in a first direction, the second moving portion is linked with the first moving portion, when the first moving portion moves close to the second moving portion in the first direction, the first moving portion drives the second moving portion to move away from the slot body; when the first moving portion moves away from the second moving portion in the first direction, the first moving portion drives the second moving portion to move close to the slot body; when the second moving portion moves away from the slot body, the sensor moves from a first position to a second position and the sensor contacts with the object.

### FIELD

The present application relates to the field of electronic devices, and particularly to a slot device.

### BACKGROUND

Usually, after inserting a memory into a motherboard slot, a temperature sensor is needed to monitor its temperature, and the closer the temperature sensor is to the memory, the more accurate the monitoring data will be. The memory is frequently plugged and unplugged and can easily cause friction or collision with the temperature sensor, causing the temperature sensor to be damaged or malfunction. Related art can use a very precise and appropriately sized motherboard slot to install the temperature sensor, to reduce the friction and collision of the temperature sensor when the memory is plugged and unplugged. However, this method is not guaranteed to reduce the friction and collision, nor does it guarantee that the temperature sensor will be tightly attached to the memory stick during monitoring to obtain accurate monitoring data.

Therefore, improvement is desired.

### BRIEF DESCRIPTION OF THE DRAWINGS

Implementations of the present application will now be described, by way of embodiments, with reference to the attached figures.

FIG. 1 is a schematic diagram of inserting a memory card into a motherboard slot.

FIG. 2 is a schematic diagram of an embodiment of a slot device of the present application.

FIG. 3 is a schematic diagram of an application scenario of the slot device of the present application.

FIG. 4 is an exploded view of the slot device of FIG. 2.

FIG. 5 is a schematic diagram of an embodiment of a slot body of the slot device of the present application.

FIG. 6 is a schematic diagram of a first embodiment of a first movement of the present application.

FIG. 7 is a schematic diagram of a first connecting portion of the present application.

FIG. 8 is a schematic diagram of a locking member of the present application.

FIG. 9A is a schematic diagram of a first embodiment of a first moving portion driving a second moving portion to move closer to the slot body of the present application.

FIG. 9B is a schematic diagram of a first embodiment of the first moving portion driving the second moving portion to move away from the slot body of the present application.

FIG. 9C is a is a schematic diagram of a first embodiment of a first elastic member disposed between the second moving portion and the slot body of the present application.

FIG. 10A is a schematic diagram of a second embodiment of a first moving portion driving a second moving portion to move closer to the slot body of the present application.

FIG. 10B is a schematic diagram of a second embodiment of the first moving portion driving the second moving portion to move away from the slot body of the present application.

FIG. 10C is a is a schematic diagram of a second embodiment of a first elastic member disposed between the second moving portion and the slot body of the present application.

FIG. 11A is a schematic diagram of a third embodiment of a first moving portion driving a second moving portion to move closer to the slot body of the present application.

FIG. 11B is a schematic diagram of a third embodiment of the first moving portion driving the second moving portion to move away from the slot body of the present application.

FIG. 11C is a is a schematic diagram of a third embodiment of a first elastic member disposed between the second moving portion and the slot body of the present application.

FIG. 12A is a schematic diagram of a fourth embodiment of a first moving portion driving a second moving portion to move closer to the slot body of the present application.

FIG. 12B is a schematic diagram of a fourth embodiment of the first moving portion driving the second moving portion to move away from the slot body of the present application.

FIG. 12C is a is a schematic diagram of a fourth embodiment of a first elastic member disposed between the second moving portion and the slot body of the present application.

FIG. 13A is a schematic diagram of a fifth embodiment of a first moving portion driving a second moving portion to move closer to the slot body of the present application.

FIG. 13B is a schematic diagram of a fifth embodiment of the first moving portion driving the second moving portion to move away from the slot body of the present application.

FIG. 13C is a is a schematic diagram of a fifth embodiment of a first elastic member disposed between the second moving portion and the slot body of the present application.

FIG. 14A is a schematic diagram of a sixth embodiment of a first moving portion driving a second moving portion to move closer to the slot body of the present application.

FIG. 14B is a schematic diagram of a sixth embodiment of the first moving portion driving the second moving portion to move away from the slot body of the present application.

FIG. 14C is a is a schematic diagram of a sixth embodiment of a first elastic member disposed between the second moving portion and the slot body of the present application.

FIG. 15A is a schematic diagram of a seventh embodiment of a first moving portion driving a second moving portion to move closer to the slot body of the present application.

FIG. 15B is a schematic diagram of a seventh embodiment of the first moving portion driving the second moving portion to move away from the slot body of the present application.

### DETAILED DESCRIPTION

The technical solutions in the embodiments of the present application will be described below in conjunction with the accompanying drawings in the embodiments of the present application, and the described embodiments are only a portion of the embodiments of the present application and not all of the embodiments.

In the description of the embodiments of the present application, the terms “exemplary”, “or”, and “for example” are used to indicate examples, illustrations, or descriptions.

In the embodiment of the present application, the words “first” and “second” are only used to distinguish different objects and cannot be understood as indicating or implying relative importance, or as indicating or implying order.

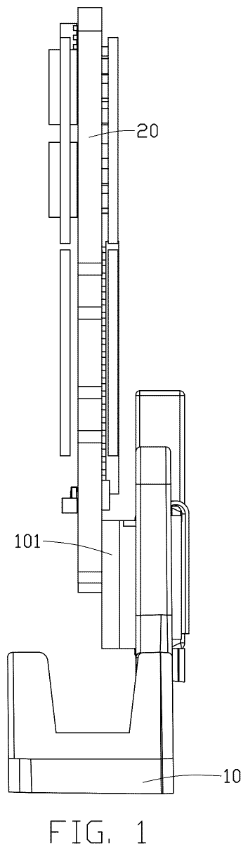

FIG. 1 illustrates a scenario where a memory card 20 is inserted into a motherboard slot 10.

When the integrated circuit (IC) of the memory card 20 is at non-operating temperature, there may be a risk of operating errors. Therefore, the memory card 20 needs to be temperature monitored using a temperature sensor 101 after it is inserted into the motherboard slot 10 (i.e., the slot device of the motherboard), and the motherboard or the entire system will allow the memory card 20 to operate only when the temperature of the memory card 20 is in the range of the operating temperature. The closer the temperature sensor 101 is to the memory stick 20 to monitor the data, the more accurate it is, preferably with a tight contact. Referring to FIG. 1, the surface of the memory card 20 is not a flat surface, and the memory card 20 needs to be frequently plugged and unplugged during use, and the relative positions of the temperature sensor 101 and the memory card 20 are fixed, which can easily cause friction or collision between the memory card 20 and the temperature sensor 101, and may result in damage to the temperature sensor 101 or the memory card 20. Related art can use a very precise and appropriately sized motherboard slot to install the temperature sensor, to reduce the friction and collision of the temperature sensor when the memory is plugged and unplugged. However, this method is to insert the memory card 20 in such a way that it maintains a very small gap with the temperature sensor 101, and therefore does not ensure that the friction collision problem is reduced, and at the same time the existence of this gap may lead to the diffusion of the heat flow making the monitoring of the temperature sensor 101 inaccurate, it is very difficult for this method to allow the temperature sensor 101 to obtain accurate monitoring data.

The present application provides a slot device that can reduce the problem of friction and collision between the object and the sensor assembly, provide effective protection for the sensor assembly, and improve the accuracy of the sensing data obtained by the sensor assembly.

Embodiments of the present application will be described below in connection with the accompanying drawings.

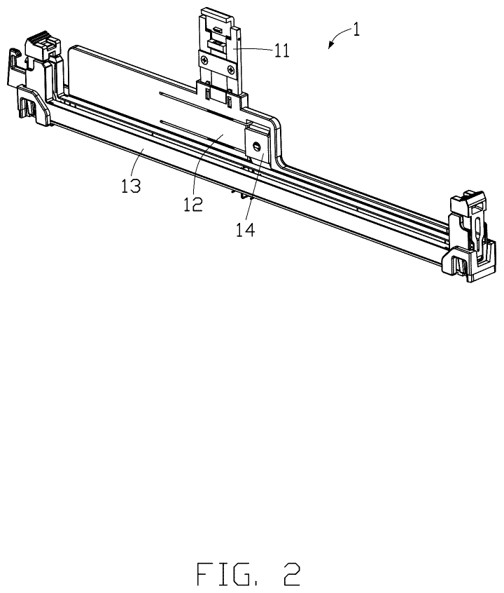

FIGS. 2 to 4 illustrate a slot device 1 in accordance with an embodiment of the present application.

The slot device 1 includes a slot body 13, a first moving portion 11, a second moving portion 12, and a sensor 14.

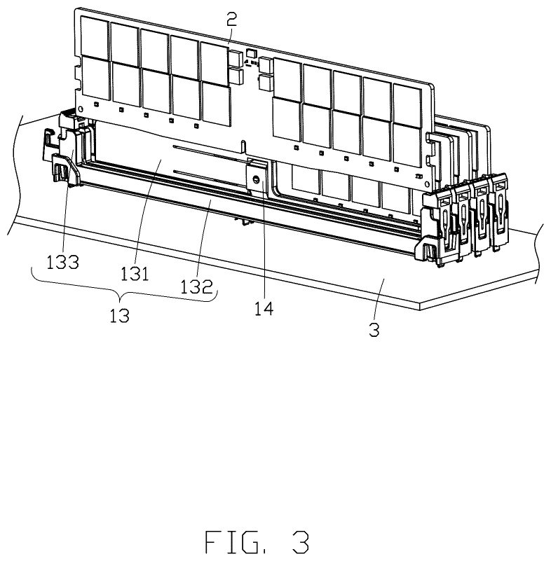

Referring to FIG. 3, the slot device 1 can be installed on a computer motherboard or on a test device 3, and the slot device 1 can be used for insertion of the memory card or other objects that need to be used for use in the computer motherboard or the test set 3. The memory cards or other objects that need to be used for use in the computer motherboard or the test device 3 are collectively referred to the object 2. The slot body 13 can be used for inserting the object 2. The object 2 can be a dual inline memory module (DIMM) memory card or a single inline memory module (SIMM) memory card, and the slot body 13 may have slots that match the DIMM memory cards or the SIMM memory card.

In some embodiments, referring to FIG. 3, corresponding to the number of the objects 2, the slot device 1 can include a plurality of slot bodies 13, a plurality of first moving portions 11, a plurality of second moving portions 12, and a plurality of sensors 14. In other words, one slot body 13, one first moving portion 11, one second moving portion 12, and one sensor 14 can form a unit of a slot device 1, which is used for inserting one object 2. When there are a plurality of objects 2, a plurality of slot bodies 13, a plurality of first moving portions 11, a plurality of second moving portions 12, and a plurality of sensors 14 can form a plurality of slot devices 1.

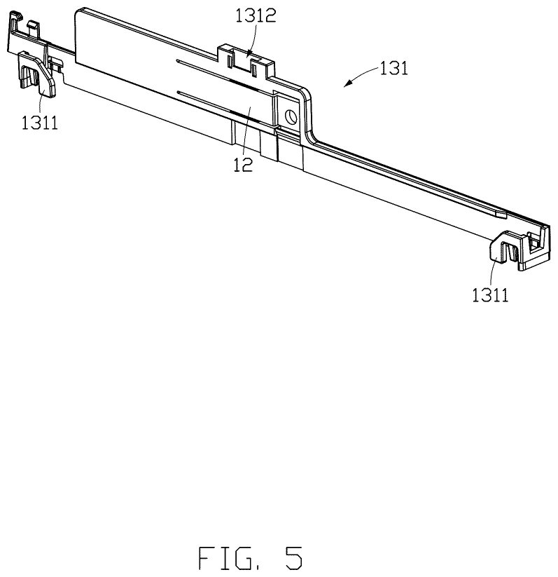

Referring to FIG. 5, the slot body 13 includes a base plate 131, a slot portion 132, a fixing portion 133 and a circuit connection portion, the slot portion 132 defines a slot for receiving the object 2, the fixing portion 133 is disposed in the slot portion 132, and the fixing portion 133 is matched with the slot portion 132 to fix the object 2 inserted into the slot. The circuit connection portion is disposed in the slot of the slot portion 132, and the circuit connection portion is used to electrically connect the motherboard and the object 2. The base plate 131, the slot portion 132, and the fixing portion 133 are made of non-metallic materials, and the circuit connection portion is made of conductive metal materials.

The base plate 131 can be in the shape of a long plate, and a long side portion of the base plate 131 extends in the direction of a plate surface of the long plate, and then extends parallel to the plate surface of the long plate to form a slot hook 1311. In the embodiment, the slot hook 1311 may be used to install and fix the slot portion 132.

In some embodiments, the slot may be a slot hook 1311 formed by entire extending a long side portion of the base plate 131. In another embodiment, the slot may be a plurality of slot hooks 1311 formed by partially extending a long side portion of the base plate 131, and the plurality of slot hooks 1311 are parallel and evenly distributed on the long side portion.

In some embodiments, a portion of the long plate surface of the base plate 131 has a larger area than the remaining portion. The portion with a larger area can be used to set the first moving portion 11 and the second moving portion 12, while the portion with a smaller area can be used to optimize space utilization and reduce the weight of the base plate 131.

In some embodiments, the portion with a larger area can form a hollow structure, which can facilitate the installation of the second moving portion 12 or the 14, this can save space. In some embodiments, the second moving portion 12 provided in the hollow structure may be integrally formed with the base plate 131, and the second moving portion 12 can have elasticity to facilitate elastic movement.

In some embodiments, the base plate 131 defines a through hole 1312 oriented in the same direction as the movement direction of the first moving portion 11, the through hole 1312 is used for installing the first moving portion 11. The portion of the first moving portion 11 passing through the through hole 1312 can act on the second moving portion 12, thereby linking the second moving portion 12.

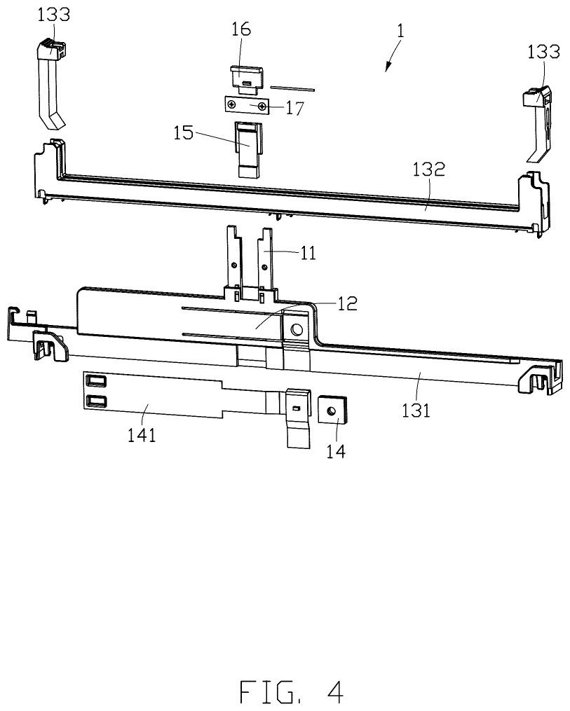

Referring to FIG. 4, the slot portion 132 is a slender square body, and the square body defines a groove that can match the shape of the object 2.

In some embodiments, the top of the slot portion 132 can form a raised end towards the insertion direction of the object 2, and the raised end can be used to set the fixing portion 133. The slot portion 132, the raised end, and the fixing portion 133 can frame the object 2 inserted into the slot, thereby enhancing the stability of fixing the object 2.

Referring to FIG. 4, the 133 can be set at both ends of the slot portion 132, and the fixing portion 133 can be a buckle set at both ends of the slot portion 132.

In some embodiments, the circuit connection portion can be disposed in the slot of the slot portion 132. The circuit connection portion can contact the conductive contacts (commonly known as “golden fingers”) of the object 2 when the object 2 is inserted into the slot. As a result, the motherboard is electrically connected to the object 2 through the circuit connection portion.

In the embodiment, the first moving portion 11 can be disposed on the slot body 13 and can move relative to the slot body 13. More specifically, the first moving portion 11 can perform reciprocating motion relative to the slot body 13 in the first direction. The first direction is consistent with the direction in which the object 2 is inserted into the slot body 13, when the first moving portion 11 reciprocates in the first direction relative to the slot body 13, the first moving portion 11 can approach or move away from the second moving portion 12.

In some embodiments, the first moving portion 11 is located at the portion with a larger area of the base plate 131 of the slot body 13, and the contact between the first moving portion 11 and the base plate 131 can be increased to enhance their stability.

In some embodiments, a guide rail is disposed between the first moving portion 11 and the slot body 13, and the first moving portion 11 reciprocates along the first direction relative to the slot body 13 through the guide rail.

In some embodiments, the slot body 13 defines a groove rail accommodating the first moving portion 11, and the first moving portion 11 can have a convex rail disposed in the groove rail, and the convex rail uses the groove rail as a guide rail for movement. In another embodiment, the groove rail can also be defined in the first moving portion 11, and the base plate 131 of the slot body 13 can have a convex rail disposed in the groove rail, and the convex rail uses the groove rail as a guide rail for movement. The groove rails can be two and distributed in the slot body 13 or the first moving portion 11, the number of convex rails can correspond to the number of groove rails, and the convex rails can also be two. Therefore, it is convenient for the first moving portion 11 to move relative to the slot body 13.

In another embodiment, referring to FIG. 4, the first moving portion 11 can be disposed in the slot body 13 through the first connecting portion 15, and the first moving portion 11 can be easily assembled into the slot body 13 through the first connecting portion 15.

The first connecting portion 15 can be fixed on the slot body 13, a guide rail is provided between the first moving portion 11 and the first connecting portion 15, and the first moving portion 11 can reciprocate in the first direction relative to the first connecting portion 15 through the guide rail. Therefore, the first moving portion 11 can also reciprocate in the first direction relative to the slot body 13, and by setting the first connecting portion 15, the shape of the slot body 13 can be optimized to improve the space utilization of the slot device 1.

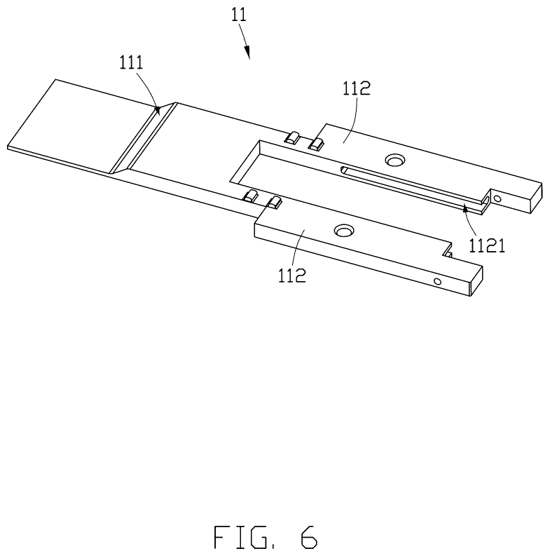

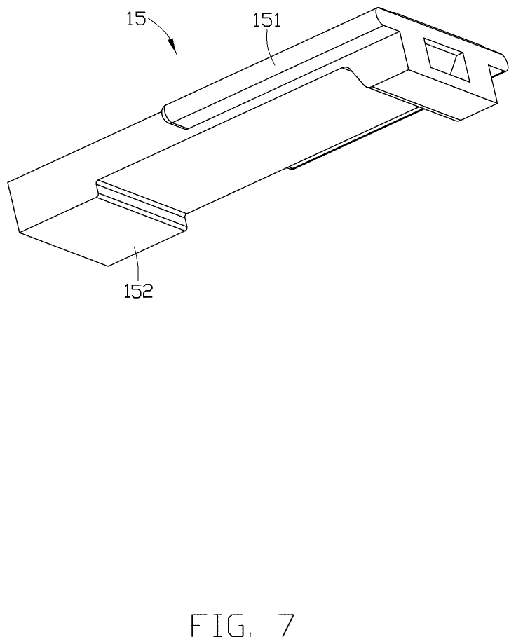

Referring to FIG. 6, the first moving portion 11 defines a groove 1121 for accommodating a part of the first connecting portion 15. Referring to FIG. 7, the first connecting portion 15 includes a flange 151 disposed in the groove 1121, and the flange 151 uses the groove 1121 as a guide rail for movement. In another embodiment, the groove 1121 can be defined at the first connecting portion 15, and the first moving portion 11 can have a flange 151 disposed in the groove 1121, and the flange 151 uses the groove 1121 as a guide rail for movement. The groove 1121 can be two and distributed in the first moving portion 11 or the first connecting portion 15, the number of flanges 151 can correspond to the number of grooves 1121, and the flanges 151 can also be two. Therefore, it is convenient for the first moving portion 11 to move relative to the first connecting portion 15.

In some embodiments, referring to FIG. 6, the first moving portion 11 can be roughly a fork portion 112, and the inner side surface of the fork portion 112 of the first moving portion 11 defines a groove 1121 that accommodates a part of the first connecting portion 15. Referring to FIG. 7, the first connecting portion 15 includes a flange 151 disposed in the groove 1121, and the flange 151 uses the groove 1121 as a guide rail for movement. In another embodiment, the groove 1121 can be defined at the first connecting portion 15, and the fork portion of the first moving portion 11 can have a flange 151 disposed in the groove 1121, and the flange 151 uses the groove 1121 as a guide rail for movement. The groove 1121 can be two and distributed in the inner side surface of the fork portion 112 of the first moving portion 11 or the first connecting portion 15, the number of flanges 151 can correspond to the number of grooves 1121, and the flanges 151 can also be two. Therefore, it is convenient for the first moving portion 11 to move relative to the first connecting portion 15.

In some embodiments, referring to FIG. 4, the first moving portion 11, which is roughly the fork portion 112, can be stably assembled on the fork portion 112 with the first connecting portion 15 by a reinforcement member 17, so that the stability between the first connecting portion 15 and the first moving portion 11 can be utilized to make the first moving portion 11 more stable when it reciprocates in the first direction.

In some embodiments, referring to FIG. 7, the first connecting portion 15 includes a clamping block 152, the clamping block 152 is used for clamping when the first connecting portion 15 and the first moving portion 11 are installed in the through hole 1312 of the base plate 131, this allows the first moving portion 11 to move relative to the first connecting portion 15 or the base plate 131.

Referring to FIGS. 2 and 4, the sensor 14 can be disposed on the second moving portion 12. The sensor 14 can be disposed on one side of the second moving portion 12 away from the slot body 13. Therefore, when the second moving portion 12 moves away from the slot body 13, the sensor 14 can be carried by the second moving portion 12 from a first position to a second position to contact the object 2 and monitor the sensing data of the object 2. Alternatively, when the second moving portion 12 moves close to the slot body 13, the sensor 14 can be carried by the second moving portion 12 from the second position to the first position to reduce the friction of the 2 when the object 2 is inserted into the slot device 1.

In some embodiments, the sensor 14 may be a temperature sensor, and the sensing data can be temperature sensing data. The sensor 14 can be a semiconductor temperature sensor, such as a temperature sensor based on bipolar junction transistor (BJT).

In another embodiments, the sensor 14 may also be various types of sensors other than temperature sensors, such as stroke sensors, current sensors, or position sensors. The sensing data may be data such as travel, electrical parameter or position.

In the embodiment of the present application, when the sensor 14 moves from the second position to the first position, and a maximum distance of the movement does not exceed 1 mm (mm). In this case, the space occupation can be reduced, so that more slot bodies 13, first moving portion 11, second moving portion 12, and sensors 14 can be disposed in the slot device 1. Therefore, the plurality of objects 2 can be inserted into the slot device 1 at once and their sensing data can be monitored simultaneously, thereby improving the efficiency of the motherboard or the test device 3.

In some embodiments, referring to FIG. 4, the sensor 14 can be electrically connected to a central processor of the motherboard or a central processor of the test device 3 through a flexible circuit board 141, thereby transmitting the sensing data to the central processor of the motherboard or the central processor of the test device 3 for data processing.

In some embodiments, referring to FIG. 4, the slot device 1 further includes a locking member 16, the locking member 16 is rotatably disposed on the first moving portion 11 to lock the object 2 to the slot device 1 when the object 2 is inserted into the slot device 1 and the first moving portion 11 moves close to the second moving portion 12 along the first direction. Therefore, if the object 2 is normally inserted into the slot device 1, the locking member 16 is rotated to lock the object 2 when the first moving portion 11 moves close to the second moving portion 12. If the object 2 is not inserted into the slot device 1 or the object 2 is not pulled out from the slot device 1, the locking member 16 is rotated to a locked state when the first moving portion 11 moves close to the second moving portion 12, this can reduce the problem that the sensor 14 is already in the second position due to the movement of the first moving portion 11 before inserting the object 2 into the slot device 1, resulting in the friction collision of the object 2 when inserting the object 2, or this can reduce the problem that the sensor 14 is still in the second position because the first moving portion 11 does not move away from the second moving portion 12 when the object 2 is not pulled out from the slot device 1, resulting in friction collision between the object 2 and the sensor 14 when the object 2 is pulled out.

In some embodiments, the locking member 16 is disposed at the top of the first moving portion 11. Therefore, the first moving portion 11 can be driven by the locking member 16, and the locking member 16 can act as a handle of the moving portion, which can facilitate the user to operate the first moving portion 11.

In some embodiments, referring to FIG. 8, the locking member 16 includes a locking brim 161. When the object 2 is normally inserted into the slot device 1, the locking member locking member 16 rotates and locks the object 2 by the locking brim 161.

In some embodiments, referring to FIG. 8, the locking member 16 further includes a locking bump 162. When the locking member 16 moves a certain distance close to the second moving portion 12 in the first direction following the first moving portion 11, and the locking member 16 rotates to a preset angle (such as an angle required to lock the object 2), the locking bump 162 can be engaged with the first connecting portion 15 to lock the object 2. When the force of rotating the locking member 16 is greater than the static friction force of the locking bump 162, the locking member 16 is unlocked and can be rotated.

In some embodiments, referring to FIG. 8, the locking member 16 further includes a tail 163. When the locking member 16 moves a certain distance away from the second moving portion 12 in the first direction following the first moving portion 11, and the locking member 16 rotates to another preset angle (such as an angle when it is not necessary to lock the object 2), the tail 163 of the locking member 16 can be clamped to the first connecting portion 15. When the force of rotating the locking member 16 is greater than the static friction force of the tail 163 of the locking member 16 clamping on the first connecting portion 15, the locking member 16 can be rotated.

In the embodiment of the present application, when the first moving portion 11 moves close to the second moving portion 12 along the first direction, the first moving portion 11 can drive the second moving portion 12 to move away from the slot body 13. When the first moving portion 11 moves away from the second moving portion 12 along the first direction, the first moving portion 11 can drive the second moving portion 12 to move close to the slot body 13. When the second moving portion 12 moves away from the slot body 13, the sensor 14 can move from the first position to the second position, and the sensor 14 contacts with the object 2. When the second moving portion 12 moves close to the slot body 13, the sensor 14 can move from the second position to the first position and away from the object 2.

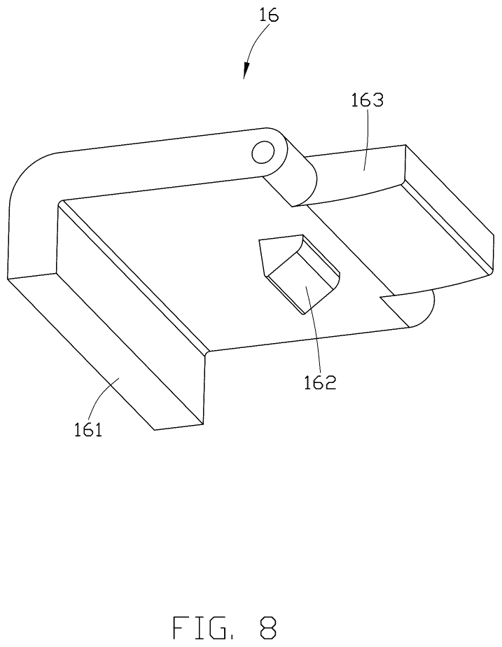

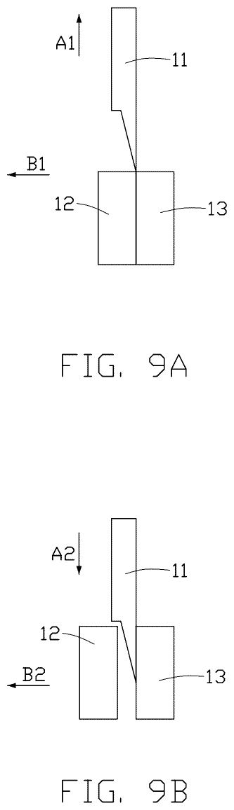

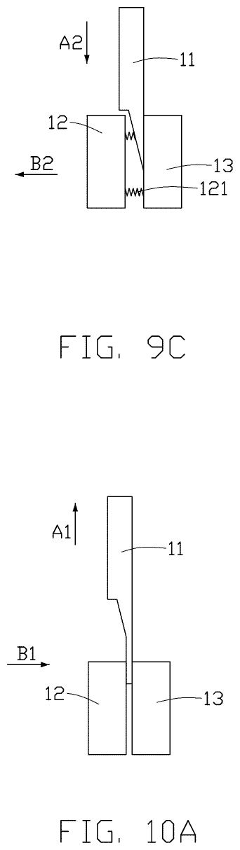

In some embodiments, referring to FIGS. 9A to 10C, one end of the first moving portion 11 near the second moving portion 12 can have a tapered shape, the end face of one end of the first moving portion 11 can have a sloping surface 111. When the first moving portion 11 reciprocates in the first direction relative to the first connecting portion 15, the tapered end or the sloping surface 111 of the first moving portion 11 can drive the second moving portion 12 to move close to or away from the slot body 13 by expanding the second moving portion 12. The contact area is reduced by moving the first moving portion 11 away from the second moving portion 12, as shown in in FIGS. 9A to 10C, the first moving portion 11 moves in the direction Al, so that the second moving portion 12 is reset to move close to the slot body 13, for example, as shown in FIGS. 9A to 10C, the second moving portion 12 moves in the direction B1. Alternatively, the present application contacts the second moving portion 12 through the tapered end or the sloping surface 111 and moves the first moving portion 11 close to the second moving portion 12 to increase the contact area, as shown in in FIGS. 9A to 10C, the first moving portion 11 moves in the direction A2, so that the second moving portion 12 is expanded to move away from the slot body 13, for example, as shown in FIGS. 9A to 10C, the second moving portion 12 moves in the direction B2.

In some embodiments, the distance that the second moving portion 12 moves towards or away from the slot body 13 may not exceed 1 mm (millimeters). By controlling the taper end or the or the slope surface 111 of the first moving portion 11 to contact the second moving portion 12, the movement distance of the second moving portion 12 towards or away from the slot body 13 can be controlled more accurately and stably. Thus, the space of the slot unit 1 can be saved to arrange more slot bodies slot body 13, first moving portions 11, second moving portions second moving portion 12 and sensors 14.

In some embodiments, as shown in FIG. 9A, before the first moving portion 11 moves close to the second moving portion 12, the first moving portion 11 may not need to be located between the second moving portion 12 and the slot body 13, there is a preset gap between the second moving portion 12 and the slot body 13, and the position of the preset gap corresponds to the lowest point of the tapered end or the sloping surface 111. Therefore, when the first moving portion 11 moves close to the second moving portion 12, the second moving portion 12 is driven to move by the tapered end or the sloping surface 111 entering the preset gap between the second moving portion 12 and the slot body 13, the process state shown in FIG. 9A to FIG. 9B.

In some embodiments, as shown in FIG. 9C, the slot device 1 further includes an elastic member, referred to here as a first elastic member 121 for ease of distinction. The first elastic member 121 is disposed between the second moving portion 12 and the slot body 13. When the first moving portion 11 drives the second moving portion 12 to move close to or away from the slot body 13 by expanding the second moving portion 12, the first elastic member 121 connects the second moving portion 12 and the slot body 13 and assists the second moving portion 12 to reset, thereby improving the stability between the second moving portion 12 and the slot body 13.

In another embodiment, referring to FIG. 10A, before the first moving portion 11 moves close to the second moving portion 12, the first moving portion 11 may be partially located between the second moving portion 12 and the slot body 13, there is a preset gap between the second moving portion 12 and the slot body 13, and the part of the first moving portion 11 located in the preset gap may be a plane. Therefore, when the first moving portion 11 moves close to the second moving portion 12, a part of the tapered end or the sloping surface 111 located in the preset gap guides and enters the preset gap between the second moving portion 12 and the slot body 13 to drive the second moving portion 12 to move, as shown in the process states in FIGS. 10A to 10B, thereby improving the accuracy of the movement of the second moving portion 12 driven by the first moving portion 11.

Similarly, referring to FIG. 10C, in the embodiments shown in FIGS. 10A and 10B, the slot device 1 also includes a first elastic member 121. The first elastic member 121 is disposed between the second moving portion 12 and the slot body 13. When the first moving portion 11 drives the second moving portion 12 to move close to or away from the slot body 13 by expanding the second moving portion 12, the first elastic member 121 connects the second moving portion 12 and the slot body 13 and assists the second moving portion 12 to reset, thereby improving the stability between the second moving portion 12 and the slot body 13.

In addition to the method in which the first moving portion 11 drives the second moving portion 12 to move through a tapered end or a sloping surface 111 in the above embodiments, the present application also provides another driving method, for example, a linkage component 122 can be disposed between the second moving portion 12 and the slot body 13. When the first moving portion 11 reciprocates in the first direction relative to the first connecting portion 15, the first moving portion 11 drives the second moving portion 12 to move away from or close to the slot body 13 by driving the linkage component 122 to expand the second moving portion 12. A plurality of linkage components 122 can be evenly distributed on one side of the second moving portion 12 close to the slot body 13. In this case, the first moving portion 11 drives evenly distributed linkage components 122 to drive the second moving portion 12 to move, due to the consistent movement of the plurality of linkage components 122, this can avoid damage to the second moving portion 12 due to the inconsistent movement of the second moving portion 12 or the uneven stress of the second motion part second moving portion 12.

In some embodiments, the linkage component 122 may have a variety of structures, some embodiments are provided below for illustration.

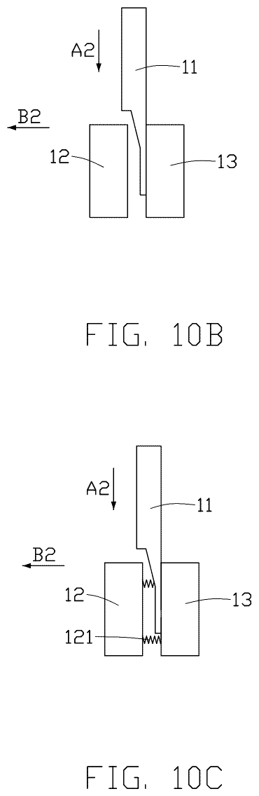

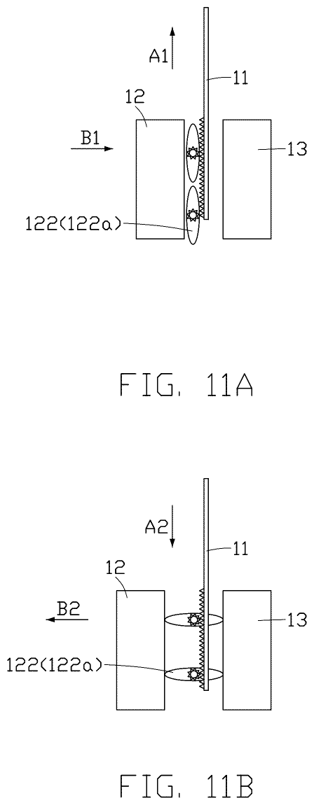

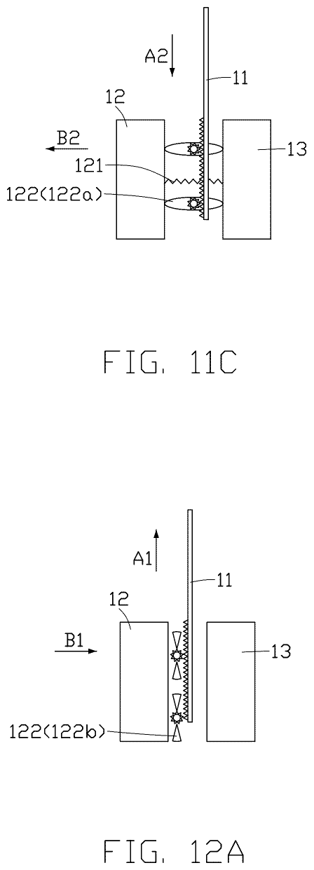

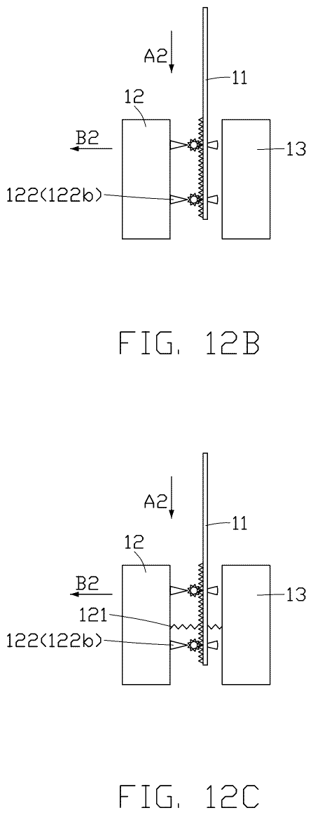

In some embodiments, as shown in FIGS. 11A to 12C, the linkage component 122 includes a roller disposed on the slot body 13 and an expanding member coaxially disposed on the roller, the axis direction of the roller is the same as the long side direction of the slot body 13, and the axis direction of the roller is orthogonal to the first direction. When the first moving portion 11 reciprocates in the first direction relative to the first connecting portion 15, the first moving portion 11 drives the second moving portion 12 to move away from or close to the slot body 13 by driving the roller to rotate the expanding member and expand the second moving portion 12.

In some embodiments, as shown in FIGS. 11A to 11C, in the linkage component 122a, the radial cross-section of the expanding member is elliptical, and its contour can always adhere to the surface of the second moving portion 12, thereby improving the stability of the second moving portion 12. When the first moving portion 11 reciprocates in the first direction relative to the first connecting portion 15, the first moving portion 11 drives the second moving portion 12 to move away from or close to the slot body 13 by driving the roller to rotate the expanding member with an elliptical radial cross-section and expand the second moving portion 12, this is the state process shown in FIGS. 11A and 11B. A1 is the direction in which the first moving portion 11 moves away from the second moving portion 12, A2 is the direction in which the first moving portion 11 moves close to the second moving portion 12, B1 is the direction in which the second moving portion 12 moves close to the slot body 13, and B2 is the direction in which the second moving portion 12 moves away from the slot body 13.

Similarly, referring to FIG. 11C, in the embodiments shown in FIGS. 11A and 11B, the slot device 1 also includes a first elastic member 121. The first elastic member 121 is disposed between the second moving portion 12 and the slot body 13. When the first moving portion 11 drives the second moving portion 12 to move close to or away from the slot body 13 by expanding the second moving portion 12, the first elastic member 121 connects the second moving portion 12 and the slot body 13 and assists the second moving portion 12 to reset, thereby improving the stability between the second moving portion 12 and the slot body 13.

In some embodiments, in the linkage component 122b, the radial cross-section of the support piece is fan-shaped, when it does not move the second moving portion 12 away from the slot body 13, the space occupied is minimized, which can save space. When the first moving portion 11 reciprocates in the first direction relative to the first connecting portion 15, the first moving portion 11 drives the second moving portion 12 to move away from or close to the slot body 13 by driving the roller to rotate the expanding member with a fan-shaped radial cross-section and expand the second moving portion 12, this is the state process shown in FIGS. 12A and 12B. A1 is the direction in which the first moving portion 11 moves away from the second moving portion 12, A2 is the direction in which the first moving portion 11 moves close to the second moving portion 12, B1 is the direction in which the second moving portion 12 moves close to the slot body 13, and B2 is the direction in which the second moving portion 12 moves away from the slot body 13.

Similarly, referring to FIG. 12C, in the embodiments shown in FIGS. 12A and 12B, the slot device 1 also includes a first elastic member 121. The first elastic member 121 is disposed between the second moving portion 12 and the slot body 13. When the first moving portion 11 drives the second moving portion 12 to move close to or away from the slot body 13 by expanding the second moving portion 12, the first elastic member 121 connects the second moving portion 12 and the slot body 13 and assists the second moving portion 12 to reset, thereby improving the stability between the second moving portion 12 and the slot body 13.

In the embodiments shown in FIGS. 11A to 12C, the maximum diameter of the radial cross-section of the expanding member does not exceed 1 mm (millimeters), in other words, the maximum diameter of the ellipse or the sum of the radii of the two sectors does not exceed 1 mm. Therefore, the distance that the second moving portion 12 can be driven to move during rotation does not exceed 1 mm, and the distance that the sensor 14 moves does not exceed 1 mm.

In some embodiments, the roller may have a micro gear, and the part of the first moving portion 11 that is linked with the roller may be a tooth belt. Therefore, When the first moving portion 11 reciprocates in the first direction, it can drive the micro gear to rotate through the toothed belt, and then drive the expanding member with an elliptical or fan-shaped radial cross-section to rotate a certain angle, so as to make the second moving portion 12 to move close to or away from the slot body 13.

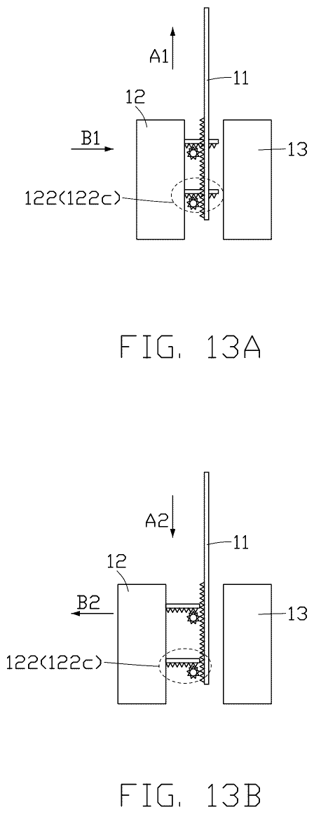

In some embodiments, referring to FIGS. 13A to 13C, the linkage component 122c comprises a roller disposed on the slot body 13 and a rod coaxially disposed on the roller, and one end of the rod is fixed to the second moving portion 12. When the reciprocates in the first direction relative to the first connecting portion 15, the first moving portion 11 drives the second moving portion 12 to move away from or close to the slot body 13 by driving the roller to make the rod to move relatively to the roller, this is the state process shown in FIGS. 13A and 13B. A1 is the direction in which the first moving portion 11 moves away from the second moving portion 12, A2 is the direction in which the first moving portion 11 moves close to the second moving portion 12, B1 is the direction in which the second moving portion 12 moves close to the slot body 13, and B2 is the direction in which the second moving portion 12 moves away from the slot body 13.

In some embodiments, the roller may have a micro gear, the part of the first moving portion 11 that is linked with the roller may be a tooth belt, and the part of the rod that is linked with the roller may be a tooth belt. Therefore, when the first moving portion 11 reciprocates in the first direction, the micro gear can be driven by the tooth belt to rotate, and the micro gear then drives the rod to move a certain distance, so as to make the second moving portion 12 to move close to or away from the slot body 13.

Similarly, referring to FIG. 3C, in the embodiments shown in FIGS. 13A and 13B, the slot device 1 also includes a first elastic member 121. The first elastic member 121 is disposed between the second moving portion 12 and the slot body 13. When the first moving portion 11 drives the second moving portion 12 to move close to or away from the slot body 13 by expanding the second moving portion 12, the first elastic member 121 connects the second moving portion 12 and the slot body 13 and assists the second moving portion 12 to reset, thereby improving the stability between the second moving portion 12 and the slot body 13.

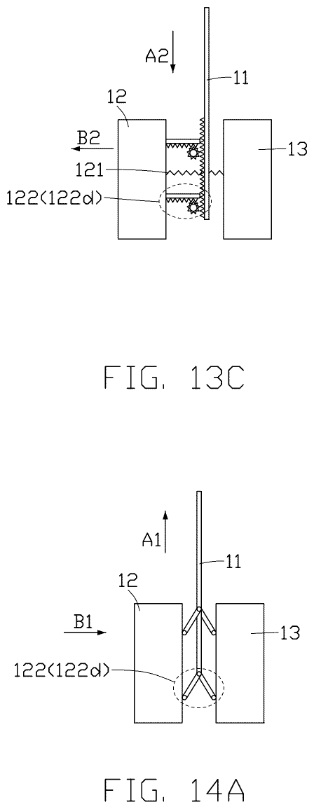

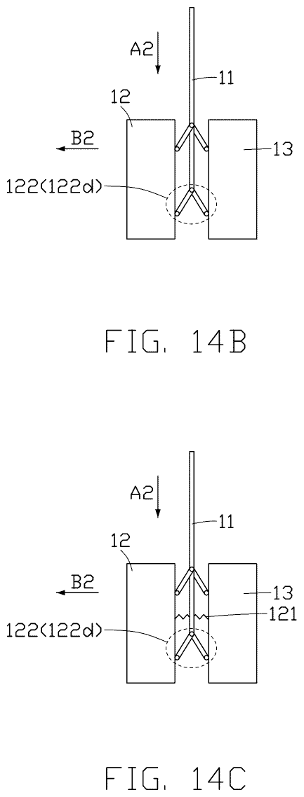

In some embodiments, referring to FIGS. 14A to 14C, the linkage component 122d includes a plurality of connecting rods, the plurality of connecting rods can be movably connected to the first moving portion 11, the second moving portion 12, and the slot body 13. For ease of description, the connecting rod that can be movably connected to the first moving portion 11 and the second moving portion 12 is referred to as a first connecting rod, and the connecting rod that can be movably connected to the first moving portion 11 and the slot body 13 is referred to as a second connecting rod. When the first moving portion 11 reciprocates in the first direction relative to the first connecting portion 15, the first moving portion 11 drives the second moving portion 12 to move away from or close to the slot body 13 by driving the first connecting rod and the second connecting rod to expand the second moving portion 12, this is the state process shown in FIGS. 14A and 14B. A1 is the direction in which the first moving portion 11 moves away from the second moving portion 12, A2 is the direction in which the first moving portion 11 moves close to the second moving portion 12, B1 is the direction in which the second moving portion 12 moves close to the slot body 13, and B2 is the direction in which the second moving portion 12 moves away from the slot body 13.

In some embodiments, the linkage component 122 includes a plurality of first connecting rods and a plurality of second connecting rods. In this case, the second moving portion 12 can be moved away from or close to the slot body 13 by using the plurality of first connecting rods and the plurality of second connecting rods to expand the second moving portion 12, which can improve the smoothness and consistency of the movement of the second moving portion 12, and thus make the sensor 14 move as a whole to contact the object 2.

In some embodiments, the first connecting rod can be movably connected to the first moving portion 11 and the second moving portion 12 through a flexible material, in other words, the part of the first connecting rod connected to the first moving portion 11 or the part of the first connecting rod connected to the second moving portion 12 can be a flexible material. Similarly, the second connecting rod can be movably connected to the first moving portion 11 and the slot body 13 through a flexible material, in other words, the part of the second connecting rod connected to the first moving portion 11 or the part of the second connecting rod connected to the slot body 13 can be a flexible material. Thus, the first connecting rod and the plurality of second connecting rods can be moved even in a space as wide as, for example, 0.9 mm, without the need for space consuming structures such as shafts.

Similarly, referring to FIG. 14C, in the embodiments shown in FIGS. 14A and 14B, the slot device 1 also includes a first elastic member 121. The first elastic member 121 is disposed between the second moving portion 12 and the slot body 13. When the first moving portion 11 drives the second moving portion 12 to move close to or away from the slot body 13 by expanding the second moving portion 12, the first elastic member 121 connects the second moving portion 12 and the slot body 13 and assists the second moving portion 12 to reset, thereby improving the stability between the second moving portion 12 and the slot body 13.

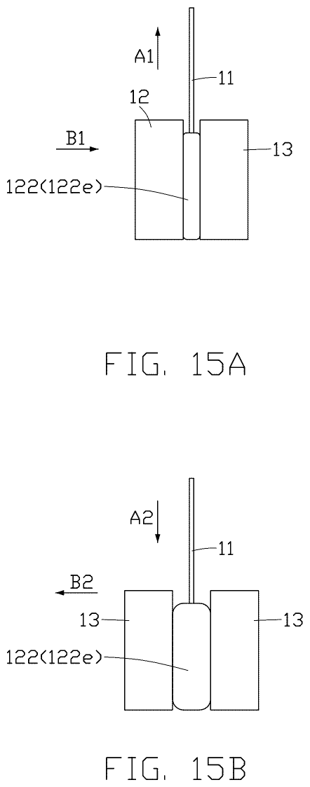

In some embodiments, referring to FIGS. 15A and 15B, the linkage component 122e can be an elastic member, and the elastic member can be disposed between the second moving portion 12 and the slot body 13. In order to distinguish the elastic member below, it is referred to as the second elastic member here. When the first moving portion 11 reciprocates in the first direction relative to the first connecting portion 15, the first moving portion 11 drives the second moving portion 12 to move away from or close to the slot body 13 by driving the second elastic member to expand and contract to expand the second moving portion 12, this is the state process shown in FIGS. 15A and 15B. The second elastic member can adhere to the second moving portion 12 when it expands and contracts. A1 is the direction in which the first moving portion 11 moves away from the second moving portion 12, A2 is the direction in which the first moving portion 11 moves close to the second moving portion 12, B1 is the direction in which the second moving portion 12 moves close to the slot body 13, and B2 is the direction in which the second moving portion 12 moves away from the slot body 13.

In some embodiments, the second elastic member may be connected to the second moving portion 12 or the slot body 13 through adhesive bonding. Thus, it can reduce the problem of the second moving portion 12 being easily damaged due to inconsistent overall movement or uneven force when directly contacting and expanding the second moving portion 12 through the first moving portion 11.

In some embodiments, the second elastic member can include but is not limited to springs, air bags, air plugs, elastic pads or expansion pads. The way in which the first moving portion 11 drives the second elastic member can be to compress the second elastic member to expand and contract in a preset direction, such as the direction in which the second moving portion 12 needs to move.

Referring to FIGS. 2 and 4, the second moving portion 12 can be disposed on the slot body 13. When the first moving portion 11 moves relative to the slot body 13, the first moving portion 11 can drive the second moving portion 12 to move relative to the slot body 13, and the second moving portion 12 can be linked with the first moving portion 11.

In some embodiments, as shown in FIG. 4 or FIG. 5, the second moving portion 12 is disposed on the larger area of the base plate 131 of the slot body 13. Therefore, the contact between the second moving portion 12 and the base plate 131 can be increased to enhance their stability.

In some embodiments, the second moving portion 12 can be made of elastic material. As shown in FIG. 4 or FIG. 5, one end of the second moving portion 12 is connected to the slot body 13, referring to FIG. 2, the sensor 14 is disposed on another end of the second moving portion 12. In some embodiments, the second moving portion 12 may define an installation slot for installing the sensor 14, and the shape of the installation slot may match the sensor 14, for example, the sensor 14 can be square, and the installation slot can also be square.

In some embodiments, as mentioned above, the second moving portion 12 can be integrated with the base plate 131 of the slot body 13. In this case, the first moving portion 11 drives one end of the second moving portion 12 to move close to or away from the slot body 13 by expanding the second moving portion 12, so that the position of the sensor 14 changes in the first position or the second position. The second moving portion 12 made of elastic material can be connected to the slot body 13 at one end away from the slot body 13 to play a stable role, and when the first moving portion 11 moves away from the second moving portion 12, the elastic material can assist the second moving portion 12 to reset, and the elastic material can assist the second moving portion 12 to move close to the slot body 13.

In another embodiment, the material of the second moving portion 12 can be the same as the material of the base plate 131 of the slot body 13, in other words, the second moving portion 12 does not have elasticity.

In all the above embodiments of the present application, the first elastic member 121 may not be necessary to be provided if the second moving portion 12 is already elastic.

In some embodiments, the first elastic member 121 can include but is not limited to springs, air bags, air plugs, elastic pads or expansion pads.

In some embodiments, the first elastic member 121 may not be necessary to be provided if the second elastic member is provided, for example, when the second elastic member is an air bag, the first moving portion 11 drives the second elastic member to expand and contract, to drive the second moving portion 12 to move close to or away from the slot body slot body 13, and the surface of the air bag is attached to the second moving portion 12 through adhesive bonding. In this case, the air bag can have both the role of the 121 and the role of the, so the first elastic member 121 may not be necessary to be provided.

In the embodiment of the present application, before the object 2 is inserted into the slot device 1, the sensor 14 is in the first position, after the object 2 is inserted into the slot device 1, the first moving portion 11 moves close to the second moving portion 12 in the first direction to drive the second moving portion 12 away from the slot body 13, and the sensor 14 moves from the first position to the second position under the drive of the second moving portion 12 and contacts the object 2.

Before the object 2 is pulled out from the slot device 1, the first moving portion 11 moves away from the second moving portion 12 in the first direction to drive the second moving portion 12 close to the slot body 13, the sensor 14 moves from the second position to the first position under the drive of the second moving portion 12 to move away from the object 2. Therefore, the problem of friction collision between the object 2 and the sensor 14 can be reduced.

The first position can refer to the position of the sensor 14 before the object 2 is inserted into the slot device 1 and the first moving portion 11 is not driven the second moving portion 12 away from the slot body 13. When the sensor 14 is in the first position and the object 2 is inserted into the slot device 1, the distance between the side of the sensor 14 close to the object 2 and the object 2 can be between 0.8 mm and 1 mm.

The second position can mean that after the object 2 is inserted into slot device 1, the first moving portion 11 moves in the first direction close to the second moving portion 12 and drives the s second moving portion 12 away from the slot body 13, and the sensor 14 follows the second moving portion 12 to the position where the sensor 14 contacts the object 2. When the sensor 14 is in the second position, the distance between the side of the sensor 14 close to the object 2 and the object 2 inserted into the slot device 1 is 0, and the sensor 14 is in contact.

In the present application, the first moving portion 11 and the second moving portion 12 can both be movably disposed on the slot body 13, the sensor 14 is disposed on the second moving portion 12. By reciprocating the first moving portion 11 in the first direction, the second moving portion 12 is driven, thereby changing the position of the sensor 14. Therefore, when the object 2 is inserted into the slot body 13, the sensor 14 can be preplaced in the first position away from the object 2 through the first moving portion 11 and the second moving portion 12, reducing the problem of friction and collision between the object 2 and the sensor 14 during insertion and removal, and providing effective protection for the sensor 14. After inserting the object 2 into the slot body 13, the sensor 14 can be placed in the second position that can contact the object 2 through the first moving portion 11 and the second moving portion 12, which can improve the accuracy of the sensor 14 in monitoring the object 2.

Even though numerous characteristics and advantages of the present technology have been set forth in the foregoing description, together with details of the structure and function of the present application, the application is illustrative only, and changes can be made in the detail, especially in matters of shape, size, and arrangement of the parts within the principles of the present application, up to and including the full extent established by the broad general meaning of the terms used in the claims. It will, therefore, be appreciated that the exemplary embodiments described above can be modified within the scope of the claims.

What is claimed is:

1. A slot device comprising a slot body, a first moving portion, a second moving portion, and a sensor, wherein:
the slot body is configured for inserting an object;
the first moving portion is movably disposed on the slot body, and the first moving portion reciprocates in a first direction;
the second moving portion is movably disposed on the slot body, and the second moving portion is linked with the first moving portion;
the sensor is disposed on the second moving portion;
when the first moving portion moves close to the second moving portion in the first direction, the first moving portion drives the second moving portion to move away from the slot body; when the first moving portion moves away from the second moving portion in the first direction, the first moving portion drives the second moving portion to move close to the slot body; when the second moving portion moves away from the slot body, the sensor moves from a first position to a second position and the sensor contacts with the object; and when the second moving portion moves close to the slot body, the sensor moves from the second position to the first position and away from the object.

2. The slot device according to claim 1, wherein the first direction is consistent with a direction in which the object is inserted into the slot body.

3. The slot device according to claim 1, wherein the second moving portion is made of elastic material, a first end of the second moving portion is connected to the slot body, the sensor is disposed at a second end of the second moving portion, the first moving portion drives the first end of the second moving portion to move close to or away from the slot body by expanding the second moving portion; or the slot device further comprises a first elastic member, and the first elastic member is disposed between the second moving portion and the slot body, the first moving portion drives the second moving portion to move close to or far away from the slot body by expanding the second moving portion.

4. The slot device according to claim 3, wherein the first moving portion is disposed on the slot body through a first connecting portion, and a guide rail is provided between the first moving portion and the first connecting portion, the first moving portion reciprocates along the first direction relative to the first connecting portion through the guide rail.

5. The slot device according to claim 4, wherein a first end of the first moving portion close to the second moving portion is tapered, when the first moving portion reciprocates in the first direction relative to the first connecting portion, the first end of the first moving portion drives the second moving portion to move close to or away from the slot body by expanding the second moving portion.

6. The slot device according to claim 4, wherein a linkage component is disposed between the second moving portion and the slot body, when the first moving portion reciprocates in the first direction relative to the first connecting portion, the first moving portion drives the linkage component to expand the second moving portion, thereby driving the second moving portion to close to or away from the slot body.

7. The slot device according to claim 6, wherein the linkage component comprises a roller disposed on the slot body and an expanding member coaxially disposed on the roller, when the first moving portion reciprocates in the first direction relative to the first connecting portion, the first moving portion drives the second moving portion to move away from or close to the slot body by driving the roller to make the expanding member to rotate and expand the second moving portion.

8. The slot device according to claim 6, wherein the linkage component comprises a roller disposed on the slot body and a rod coaxially disposed on the roller, when the first moving portion reciprocates in the first direction relative to the first connecting portion, the first moving portion drives the second moving portion to move away from or close to the slot body by driving the roller to make the rod to move relatively to the roller.

9. The slot device according to claim 6, wherein the linkage component comprises a first connecting rod and a second connecting rod, the first connecting rod is movably connected to the first moving portion and the second moving portion, the second connecting rod is movably connected to the first moving portion and the slot body; when the first moving portion reciprocates in the first direction relative to the first connecting portion, the first moving portion drives the second moving portion to move away from or close to the slot body by driving the first connecting rod and the second connecting rod to expand the second moving portion.

10. The slot device according to claim 4, wherein a second elastic member is disposed between the second moving portion and the slot body, when the first moving portion reciprocates in the first direction relative to the first connecting portion, the first moving portion drives the second moving portion to move away from or close to the slot body by driving the second elastic member to expand and contract to expand the second moving portion.

11. The slot device according to claim 4, further comprising a locking member rotatably disposed on the first moving portion, wherein the locking member is configured to lock the object in the slot device when the object is inserted into the slot device and the first moving portion moves close to the second moving portion along the first direction.

12. A slot device comprising a slot body, a first moving portion, a second moving portion, and a sensor, wherein:
the slot body is configured for inserting an object;
the first moving portion is movably disposed on the slot body, and the first moving portion reciprocates in a first direction;
the second moving portion is movably disposed on the slot body, and the second moving portion is linked with the first moving portion;
the sensor is disposed on the second moving portion;
when the first moving portion moves close to the second moving portion in the first direction, the first moving portion drives the second moving portion to move away from the slot body; when the first moving portion moves away from the second moving portion in the first direction, the first moving portion drives the second moving portion to move close to the slot body; when the second moving portion moves away from the slot body, the sensor moves from a first position to a second position and the sensor contacts with the object; and when the second moving portion moves close to the slot body, the sensor moves from the second position to the first position and away from the object;
wherein the first direction is consistent with a direction in which the object is inserted into the slot body, the second moving portion is made of elastic material, a first end of the second moving portion is connected to the slot body, the sensor is disposed at a second end of the second moving portion, the first moving portion drives the first end of the second moving portion to move close to or away from the slot body by expanding the second moving portion; or the slot device further comprises a first elastic member, and the first elastic member is disposed between the second moving portion and the slot body, the first moving portion drives the second moving portion to move close to or far away from the slot body by expanding the second moving portion.

13. The slot device according to claim 12, wherein the first moving portion is disposed on the slot body through a first connecting portion, and a guide rail is provided between the first moving portion and the first connecting portion, the first moving portion reciprocates along the first direction relative to the first connecting portion through the guide rail.

14. The slot device according to claim 13, wherein a first end of the first moving portion close to the second moving portion is tapered, when the first moving portion reciprocates in the first direction relative to the first connecting portion, the first end of the first moving portion drives the second moving portion to move close to or away from the slot body by expanding the second moving portion.

15. The slot device according to claim 13, wherein a linkage component is disposed between the second moving portion and the slot body, when the first moving portion reciprocates in the first direction relative to the first connecting portion, the first moving portion drives the linkage component to expand the second moving portion, thereby driving the second moving portion to close to or away from the slot body.

16. The slot device according to claim 15, wherein the linkage component comprises a roller disposed on the slot body and an expanding member coaxially disposed on the roller, when the first moving portion reciprocates in the first direction relative to the first connecting portion, the first moving portion drives the second moving portion to move away from or close to the slot body by driving the roller to make the expanding member to rotate and expand the second moving portion.

17. The slot device according to claim 15, wherein the linkage component comprises a roller disposed on the slot body and a rod coaxially disposed on the roller, when the first moving portion reciprocates in the first direction relative to the first connecting portion, the first moving portion drives the second moving portion to move away from or close to the slot body by driving the roller to make the rod to move relatively to the roller.

18. The slot device according to claim 15, wherein the linkage component comprises a first connecting rod and a second connecting rod, the first connecting rod is movably connected to the first moving portion and the second moving portion, the second connecting rod is movably connected to the first moving portion and the slot body; when the first moving portion reciprocates in the first direction relative to the first connecting portion, the first moving portion drives the second moving portion to move away from or close to the slot body by driving the first connecting rod and the second connecting rod to expand the second moving portion.

19. The slot device according to claim 13, wherein a second elastic member is disposed between the second moving portion and the slot body, when the first moving portion reciprocates in the first direction relative to the first connecting portion, the first moving portion drives the second moving portion to move away from or close to the slot body by driving the second elastic member to expand and contract to expand the second moving portion.

20. The slot device according to claim 13, further comprising a locking member rotatably disposed on the first moving portion, wherein the locking member is configured to lock the object in the slot device when the object is inserted into the slot device and the first moving portion moves close to the second moving portion along the first direction.
